(19) United States
(12) Patent Application Publication
(10) Pub. No.: US 2019/0251133 A1
(43) Pub. Date: Aug. 15, 2019

(54) PRESENTATION-INFORMATION SELECTION DEVICE, PRESENTATION-INFORMATION SELECTION METHOD, AND RECORDING MEDIUM

(71) Applicant: NEC Corporation, Minato-ku, Tokyo (JP)

(72) Inventor: Yoichiro HOZAKI, Tokyo (JP)

(73) Assignee: NEC Corporation, Minato-ku, Tokyo (JP)

(21) Appl. No.: 16/335,721

(22) PCT Filed: Sep. 21, 2017
(86) PCT No.: PCT/JP2017/034074

§ 371 Date: Mar. 22, 2019

(30) Foreign Application Priority Data
Sep. 23, 2016 (JP) 2016-185578

(51) Int. Cl. G06F 16/9535; G06F 16/9538; G06Q 30/06

(52) U.S. Cl. CPC G06F 16/9535; G06Q 30/0631; G06F 16/9538

(57) ABSTRACT

This presentation-information selection device is provided with the following: a current-condition information acquisition means for acquiring current condition information, which is information indicating the user's current condition; a desire information acquisition means for acquiring desire information, which is information indicating the user's desire; a candidate acquisition means for acquiring candidates for information for presentation, which are candidates for the information to be presented to the user; and an information selection means for selecting information to be presented to the user from among the candidates for information for presentation, on the basis of the difference between the current condition information and the desire information.

### TECHNICAL FIELD

The present invention relates to a presentation-information selection device, a presentation-information selection method, and a recording medium.

### BACKGROUND ART

Some techniques for estimating a user's interest and providing information, based on the estimated interest have been proposed.

For example, PTL 1 describes a method of providing a recommendation to a user of a networked system. In this method, media profiles of a plurality of users are compared and a user candidate that is similar to a first user in regard to media of interest is identified. Further, in this method, an event related to an on-line transaction by the first user is detected, and a recommendation for the detected event is generated. Furthermore, in this method, the recommendation is customized based on media in which the user candidate is interested, and the customized recommendation is provided for the user candidate.

### CITATION LIST

### Patent Literature

[PTL 1] Japanese Translation of PCT International Application Publication, No. 2013-536966

### SUMMARY OF INVENTION

### Technical Problem

A method for estimating a user's interest is important in order to provide a user with appropriate information.

For example, as one of methods for estimating a user's interest, it can be considered to include estimating a user's preference and providing information that matches the preference. However, it can be considered that the user's preference does not always coincide with his/her desire, and the user may not want the provided information although the information matches the user's preference.

In this regard, the invention described in PTL 1 describes use of a user's preference as a user's interest, but fails to provide any countermeasure against a possibility that the user's preference does not coincide with the user's desire.

An object of the present invention is to provide a presentation-information selection device, a presentation-information selection method, and a recording medium which are able to solve the problem described above.

### Solution to Problem

According to a first aspect of the present invention, a presentation-information selection device includes:

a current-status information acquisition means for acquiring current-status information being information indicating a current status of a user;

a desire information acquisition means for acquiring desire information being information indicating a desire of the user;

a candidate acquisition means for acquiring a presentation information candidate being a candidate for information to be presented to the user; and

an information selection means for selecting information to be presented to the user from among the presentation information candidates, based on a difference between the current-status information and the desire information.

According to a second aspect of the present invention, a presentation-information selection method includes:

acquiring current-status information being information indicating a current status of a user;

acquiring desire information being information indicating a desire of the user;

acquiring a presentation information candidate being a candidate for information to be presented to the user; and

selecting information to be presented to the user from among the presentation information candidates, based on a difference between the current-status information and the desire information.

According to a third aspect of the present invention, a recording medium records a program for causing a computer to execute:

acquiring current-status information being information indicating a current status of a user; acquiring desire information being information indicating a desire of the user;

acquiring a presentation information candidate being a candidate for information to be presented to the user; and

selecting information to be presented to the user from among the presentation information candidates, based on a difference between the current-status information and the desire information.

### Advantageous Effects of Invention

According to the present invention, it is possible to reflect a user's desire in selection of presentation information, to thereby increase a possibility that information desired by a user can be presented.

### BRIEF DESCRIPTION OF DRAWINGS

FIG. 1 is a schematic block diagram illustrating a functional configuration of a presentation-information selection device according to an example embodiment of the present invention;

FIG. 2 is a table illustrating an example of behavior information acquired by a current-status information acquisition unit 192;

FIG. 3 is a table illustrating an example of a current-status model;

FIG. 4 is a diagram illustrating a display example of the current-status model in a radar chart format;

FIG. 5 is a table illustrating a display example of the current-status model of a persona format;

FIG. 6 is a table illustrating an example of a desire model;

FIG. 7 is a diagram illustrating a display example of the desire model in the radar chart format;

FIG. 8 is a table illustrating a display example of the desire model of the persona format;

FIG. 9 is a table illustrating an example of a group of presentation information candidates;

FIG. 10 is a table illustrating an example of candidate score association information;

FIG. 11 is a table illustrating an example of a difference between current-status information and desire information;

FIG. 12 is a diagram illustrating a display example in which the current-status model and the desire model are displayed in a superimposed manner;

FIG. 13 is a table illustrating an example in which information is selected from presentation information candidates by an information selection unit 195;

FIG. 14 is a sequence diagram illustrating an example of a processing procedure for selecting information to be presented to the user by a presentation-information selection device 100; and

FIG. 15 is a schematic block diagram illustrating a minimum configuration of an information presentation device according to the present invention.

### EXAMPLE EMBODIMENT

Example embodiments of the present invention will be described below. However, the following example embodiments are not intended to limit the invention described in the claims. Further, not all combinations of features described in the example embodiments are essential to means for solving the invention.

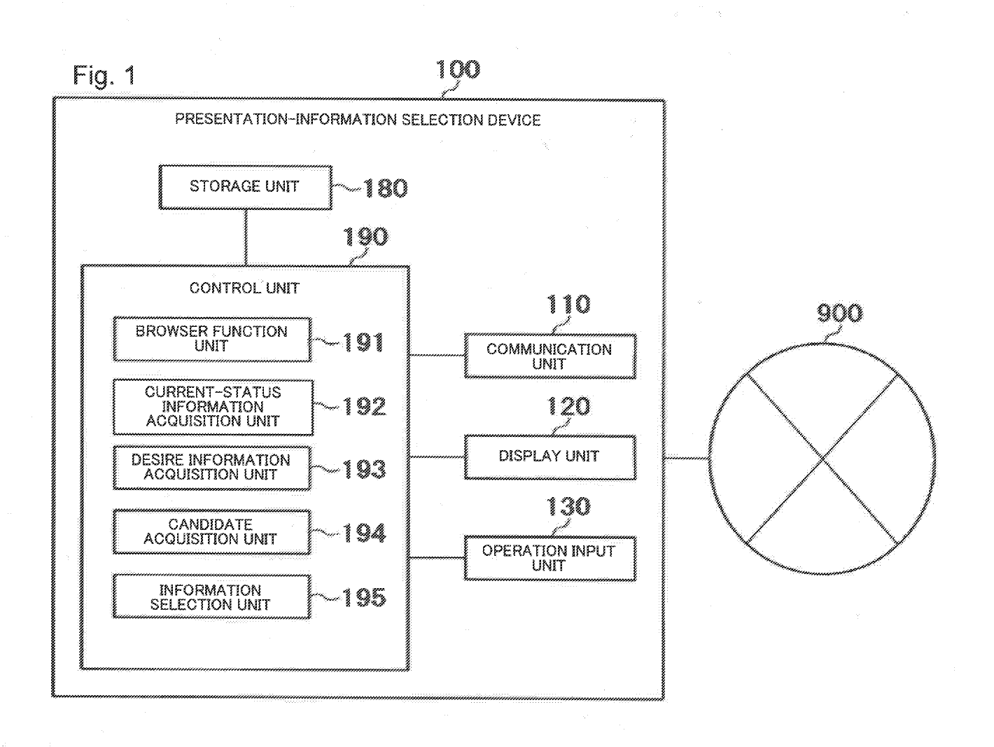

FIG. 1 is a schematic block diagram illustrating a functional configuration of a presentation-information selection device according to an example embodiment of the present invention. As illustrated in FIG. 1, a presentation-information selection device 100 includes a communication unit 110, a display unit 120, an operation input unit 130, a storage unit 180, and a control unit 190. The control unit 190 includes a browser function unit 191, a current-status information acquisition unit 192, a desire information acquisition unit 193, a candidate acquisition unit 194, and an information selection unit 195.

Further, the presentation-information selection device 100 is connected to an Internet 900 for communication.

The presentation-information selection device 100 is a device that selectively presents information to a user of the presentation-information selection device 100. The user of the presentation-information selection device 100 described herein is a person to whom the presentation-information selection device 100 presents information. The user of the presentation-information selection device 100 is hereinafter referred to simply as a user.

In this example embodiment, the presentation-information selection device 100 presents, to the user, information acquired from the Internet 900, such as article information and service information on the Internet 900. However, an information source of information to be presented to the user by the presentation-information selection device 100 is not limited to the Internet 900. For example, the presentation-information selection device 100 may be connected for communication with a database for providing information, and may acquire information from this database. Alternatively, this database may be incorporated in the presentation-information selection device 100.

The presentation-information selection device 100 is configured in such a manner that, for example, a personal computer (PC), a tablet terminal device, or a general-purpose computer such as a general-purpose server device, executes an application program having a presentation-information selection function. Alternatively, the presentation-information selection device 100 may be configured by dedicated hardware, such as a configuration using an Application

This example embodiment illustrates an example in which the presentation-information selection device 100 is integrally configured with a computer operated by the user. However, the presentation-information selection device 100 may be configured as a device separate from the computer operated by the user. Further, the presentation-information selection device 100 may be configured as a server device that presents information to (respective users of) a plurality of computers.

The communication unit 110 communicates with other devices. In particular, the communication unit 110 connects for communication with an Internet server device via the Internet 900. The Internet server device described herein refers to a computer that provides a service on the Internet.

The display unit 120 includes a display screen such as a liquid crystal panel or a Light Emitting Diode (LED) panel, and displays various images.

The operation input unit 130 includes an input device, such as a keyboard and a mouse, or a touch sensor, which is provided on the display screen of the display unit 120 and constitutes a touch panel, or a combination thereof, and receives a user's operation.

The storage unit 180 is configured by using a storage device included in the presentation-information selection device 100, and stores various information. A part or the whole of the storage unit 180 may be configured by using an external device of the presentation-information selection device 100, such as a configuration using an external storage device or a Network Attached Storage (NAS) for the presentation-information selection device 100.

The control unit 190 controls each unit of the presentation-information selection device 100 to execute various functions. The control unit 190 is configured in such a manner that a central processing unit (CPU) included in the presentation-information selection device 100 reads a program from the storage unit 180 and executes the read program. Alternatively, the control unit 190 may be configured by dedicated hardware.

The browser function unit 191 provides the user with a web browser function. A general web browser can be used as the browser function unit 191.

Note that, as described above, the presentation-information selection device 100 may be configured as a device separate from the computer operated by the user. In this case, the browser function unit 191 is provided in the computer operated by the user, and provides the user with a web browsing function.

The current-status information acquisition unit 192 acquires current-status information. The current-status information described herein refers to information indicating a current status of the user. For example, the current-status information may be information indicating a user's behavior. Alternatively, the current-status information may be information indicating a user's status, such as a qualification owned by the user, a physical status of the user, or a mental status of the user. The current-status information may also be information about an object owned by the user. The current-status information may also be a combination thereof.

This example embodiment illustrates an example in which the current-status information acquisition unit 192 acquires behavior information from the browser function unit 191, and generates a current-status model from the behavior information. Each of the behavior information and the current-status model corresponds to an example of the current-status information.

The behavior information described herein refers to information indicating a user's behavior. This example embodiment illustrates an example in which the current-status information acquisition unit 192 acquires information indicating a user's behavior in web browsing as behavior information.

Further, the current-status model described herein refers to information acquired by converting a current status of the user into a score for each item. This example embodiment illustrates an example in which the current-status information acquisition unit 192 generates a current-status model by converting article information and service information, which are browsed by the user through web browsing, into a score.

Note that a behavior model and a desire model to be described below are collectively referred to as a user model.

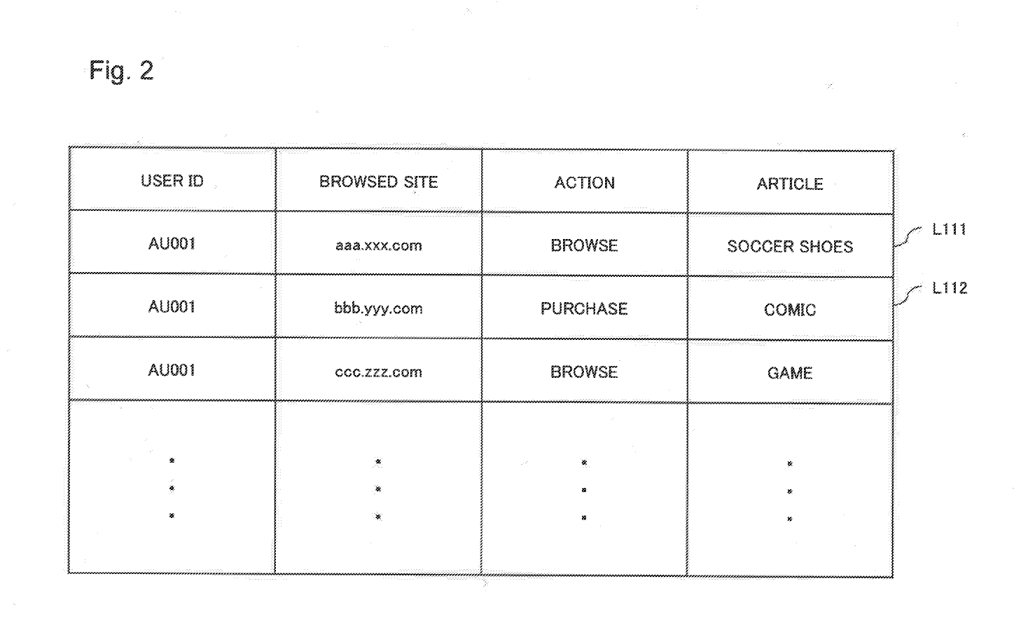

FIG. 2 is a table illustrating an example of behavior information acquired by the current-status information acquisition unit 192. In the example of FIG. 2, the behavior information is configured as information of a table format, and information corresponding to one line indicates a user's behavior for one article or service. The behavior information illustrated in FIG. 2 is configured to include a “user ID” field, a “browsed site” field, an “action” field, and an “article” field.

In the “user ID” field, a user ID is stored. The user ID is identification information for identifying a user. Note that when the number of target users of the presentation-information selection device 100 is only one, the behavior information does not necessarily include a user ID. The same also applies to other pieces of information to be described below.

In the “browsed site” field, an address of a website browsed by a user indicated by a user ID is stored.

In the “action” field, action information indicating an action (behavior) made on the site browsed by the user is stored. The term “purchase” in the action information represents that the article has been purchased. The term “browse” represents that (information about) the article has been browsed.

In the “article” field, information about an article which has become the object of the action indicated in the “action” field is stored. In the “article” field, a name of the article may be stored or information indicating a type of the article may be stored. Alternatively, a combination of these items may be stored in the “article” field.

For example, a line L111 represents that a user indicated by a user ID “AU001” has browsed (information about) soccer shoes at a website “aaa.xxx.com”. A line L112 represents that the user indicated by the user ID “AU001” has purchased a comic at a website “bbb.yyy.com”.

The current-status information acquisition unit 192 acquires information from the browser function unit 191 when the user performs web browsing. In particular, the current-status information acquisition unit 192 acquires information about an address of a browsed site, articles (article information) and services (service information) displayed on a web page browsed by the user, and an article and a service purchased by the user from among the articles and services.

Further, the current-status information acquisition unit 192 generates behavior information by using information acquired from the browser function unit 191, and stores the behavior information in the storage unit 180.

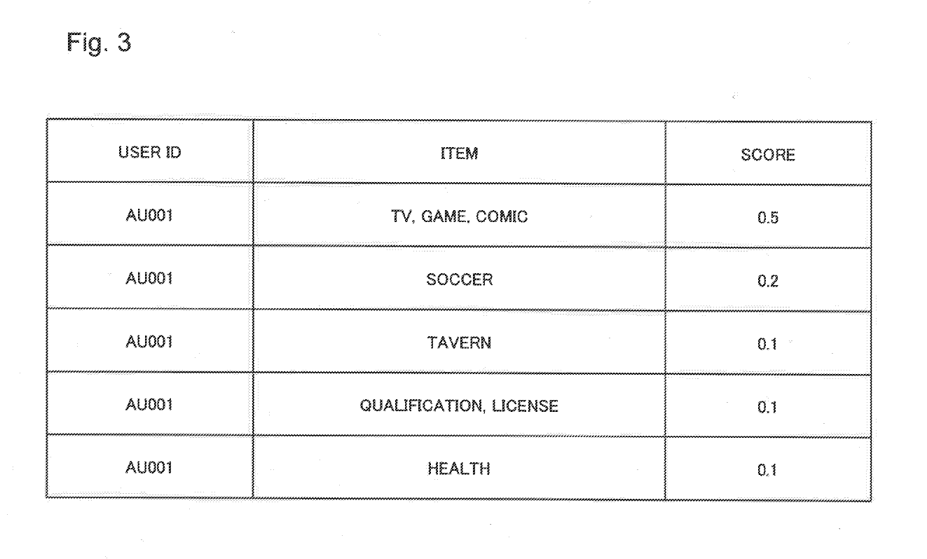

FIG. 3 is a table illustrating an example of the current-status model. In the example of FIG. 3, the current-status model is configured as information of a table format, and a score for each item is indicated in each line. The current-status model illustrated in FIG. 3 includes a “user ID” field, an “item” field, and a “score” field.

In the “user ID” field, a user ID is stored.

In the “item” field, items in which articles and services indicated by the behavior information are classified for each character are stored.

In the example of FIG. 3, articles and services for entertainment are classified into a “TV, game, comic” item.

Articles and services for sports are classified into a “soccer” item. Eating places (eating and drinking services) of the type that is available for a drinking party are classified into a “tavern” item.

Articles and services for a qualification or license, such as books and lectures for acquiring a qualification, and a driving school for acquiring a license, are classified into a qualification, license” item.

Articles and services for health, such as health-promoting goods and hospitals (medical services), are classified into a “health” item.

A score for each item in which articles and services are classified is stored in the “score” field.

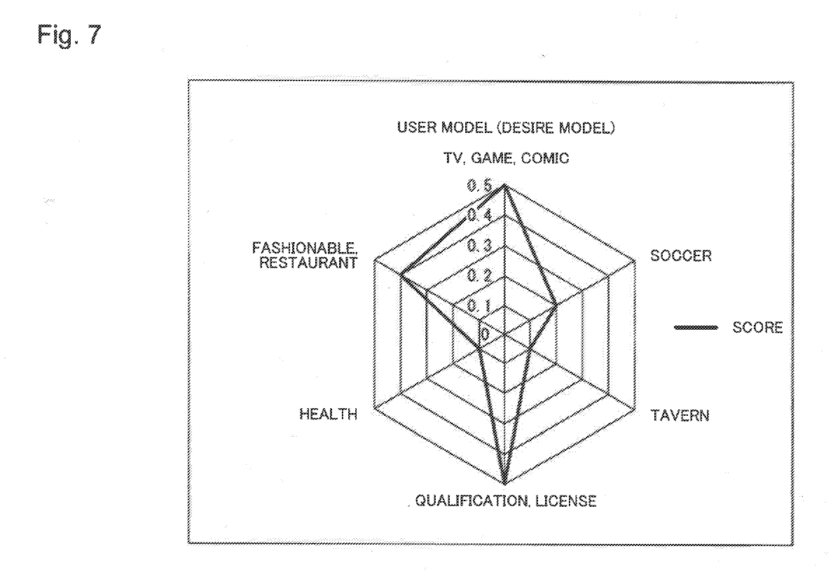

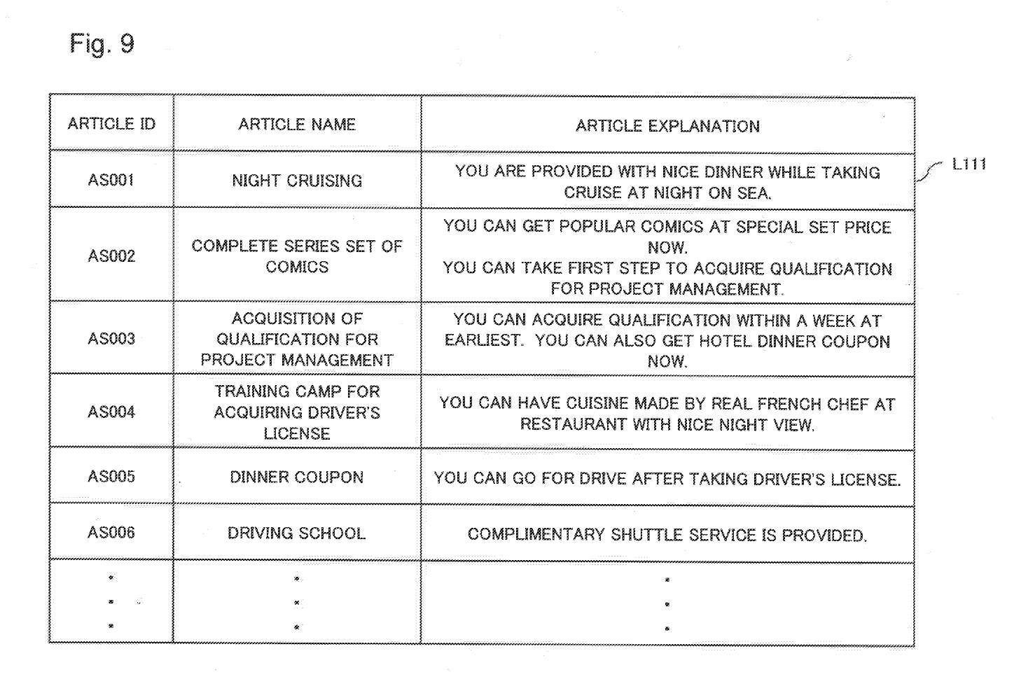

The current-status information acquisition unit 192 analyzes the behavior information corresponding to a last predetermined period, such as behavior information corresponding to the last one year which is stored in the storage unit 180, and generates a current-status model. As for the generation of the current-status model, a technique or the like described in Japanese Unexamined Patent Application Publication No. 2010-262534 (e.g., see FIGS. 7 and 9) or Japanese Patent Application 2015-062055 (Japanese Unexamined Patent Application Publication No. 2016-181196) can be used.

In order to classify articles and services into at least one item, the current-status information acquisition unit 192 may extract keywords from the description about articles and the description about services. Further, the storage unit 180 may preliminarily store information indicating the correspondence relation between a keyword and an item, and the current-status information acquisition unit 192 may classify the extracted keywords by applying the keywords to the information.

Note that the current-status information acquisition unit 192 may classify one article or service into a plurality of items.

As for calculation of a score for each item, the current-status information acquisition unit 192 may convert the sum of the number of times of browsing of articles and services classified into each item (the number of times of display on the display unit 120) into a score. Alternatively, the current-status information acquisition unit 192 may convert the total browsing time of articles and services classified into each item (a period for display on the display unit 120) into a score.

Alternatively, information about items to which respective articles and services belong and information about scores for the respective articles and services may be preliminarily determined for each article and each service. The current-status information acquisition unit 192 may classify the articles and services based on the predetermined items, and may sum up the scores for the articles and services belonging to the items for each item.

The current-status information acquisition unit 192 causes the display unit 120 to display the generated current-status model. The user rewrites the current-status model displayed on the display unit 120, thereby acquiring a desired model to be described below.

However, the format in which the display unit 120 displays the current-status model is not limited to the table format as illustrated in the example of FIG. 3. For example, the display unit 120 may display the current-status model in a radar chart format.

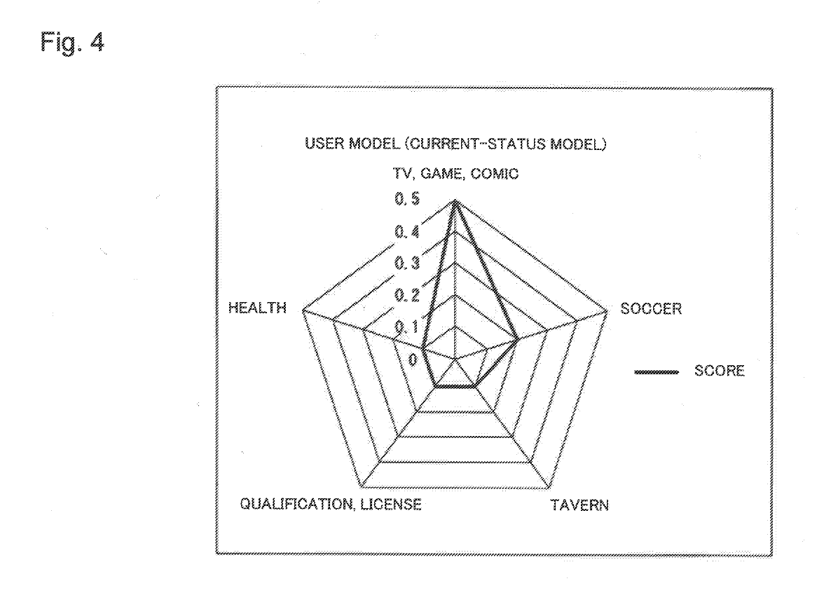

FIG. 4 is a diagram illustrating a display example of the current-status model in the radar chart format. In the example of FIG. 4, the display unit 120 displays an observation model in the example of FIG. 3 in the radar chart format.

In this manner, the display unit 120 displays the current-status model in the radar chart format, thereby enabling the user to more intuitively recognize the score in the current-status model.

The display unit 120 may display the current-status model not only in the table format, but also in the radar chart format. Alternatively, the display unit 120 may display the current-status model in the radar chart format, instead of the table format.

More alternatively, the current-status information acquisition unit 192 may generate information acquired by expressing the user's behavior in text in addition to, or instead of, the current-status model of a score format, and may display the information on the display unit 120. Hereinafter, the format in which the user's behavior is expressed in text is referred to as a persona format. The information acquired by expressing the current status of the user's behavior in the persona format is referred to as a current-status model of the persona format.

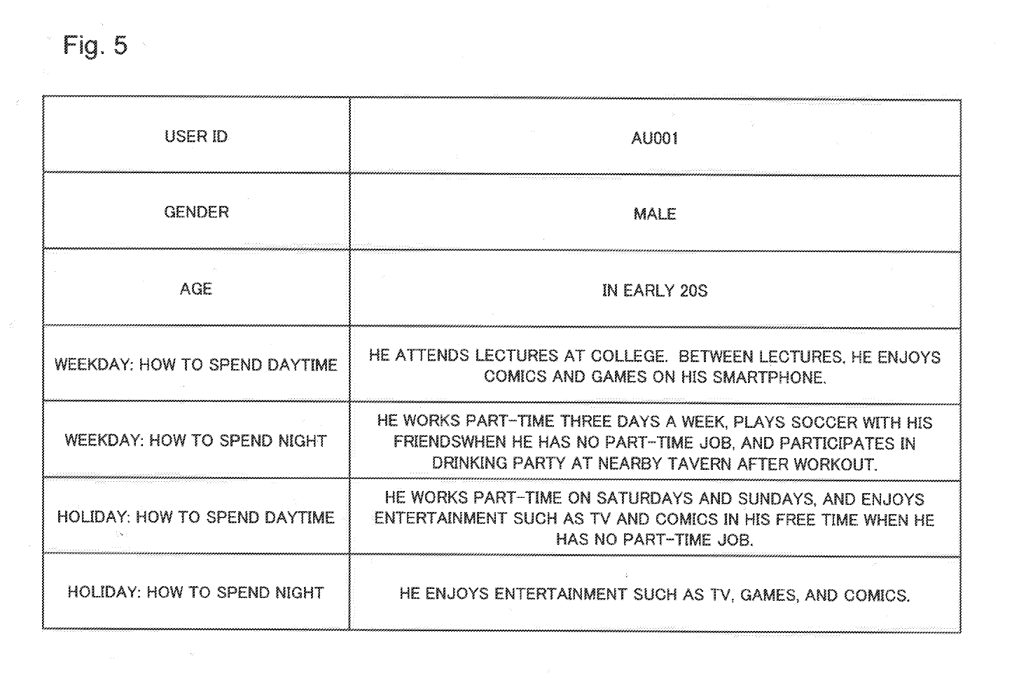

FIG. 5 is a table illustrating a display example of the current-status model of the persona format. In the example of FIG. 5, the current-status model of the persona format is configured as information of the table format.

In the current-status model of the persona format illustrated in FIG. 5, a user ID is stored in the “user ID” field. In the “gender” field, the gender of the user is stored. In the “age” field, the age of the user is stored.

The current-status model of the persona format may be displayed as information about the user himself/herself, or may be displayed as information about a fictitious person. In the “age” field, the exact age such as “00 years old” may also be stored, or an approximate age as illustrated in the example of FIG. 5 may be stored.

Alternatively, the current-status model of the persona format does not necessarily include one or both of the “gender” field and the “age” field.

In each of fields “weekday: how to spend daytime”, “weekday: how to spend night”, “holiday: how to spend daytime”, and “holiday: how to spend night”, a behavior pattern in the current status of the user in the corresponding time zone is expressed in simple text.

For example, the storage unit 180 preliminarily stores a template for the behavior pattern in each time zone. Further, the storage unit 180 preliminarily stores information about the correspondence relation between the score in the current-status model of the score format and the behavior pattern. Then, the current-status information acquisition unit 192 generates the current-status model of the persona format by referring to the score in the current-status model of the score format.

Alternatively, the current-status information acquisition unit 192 may generate the current-status model of the persona format by analyzing the behavior pattern of the user from schedule information registered by the user in a computer (presentation-information selection device 100 in this example embodiment). In this case, the schedule information corresponds to an example of the current-status information.

Alternatively, the current-status information acquisition unit 192 may generate the current-status model of the persona format by analyzing the behavior pattern of the user from profile information about a user's blog or the like. In this case, the profile information corresponds to an example of the current-status information.

The display unit 120 displays the current-status model of the persona format, thereby facilitating the user to imagine the behavior pattern of the current status of the user concretely.

The desire information acquisition unit 193 acquires desire information. The desire information described herein refers to information indicating a desire of the user. Specifically, the desire information acquisition unit 193 acquires a desire model. The desire model described herein refers to information acquired by converting the user's desire into a score for each item.

In this example embodiment, the desire information acquisition unit 193 acquires a desire model in which the user has rewritten the current-status model displayed on the display unit 120 depending on the desire of the user himself/herself.

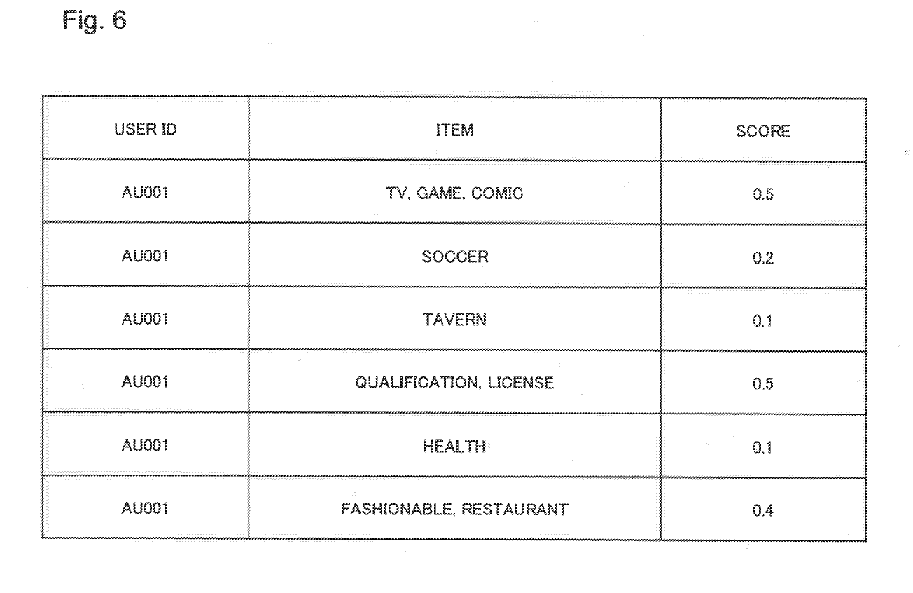

FIG. 6 is a table illustrating an example of the desire model.

In the example of FIG. 6, the user performs correction to rewrite the score for the “qualification, license” item with “0.5” on the observation model illustrated in FIG. 5. Further, the user adds a “fashionable, restaurant” item to perform correction to rewrite the score with “0.4”.

Articles and services for fashion and eating places of a restaurant type (eating and drinking services) are classified into the “fashionable, restaurant” item.

The presentation-information selection device 100 may recognize the content of the item added by the user based on keywords indicated in each item. Alternatively, the user may select any one of predetermined items in such a way that the presentation-information selection device 100 can recognize the items. For example, when the user adds a line to the desire model, the display unit 120 may display a plurality of items in a pull-down menu format and the user may select any one of the items.

FIG. 7 is a diagram illustrating a display example of the desire model in the radar chart format. In the example of FIG. 7, the display unit 120 displays the desire model in the example of FIG. 6 in the radar chart format.

In this manner, the display unit 120 displays the current-status model in the radar chart format, thereby enabling the user to more intuitively recognize the score in the current-status model.

The desire information acquisition unit 193 may cause the display unit 120 to display the desire model, which is acquired in the table format, in the radar chart format.

Alternatively, as illustrated in the example of FIG. 4, the user may rewrite the current-status model displayed in the radar chart format on the display unit 120. In this case, the desire information acquisition unit 193 may acquire the rewritten current-status model as the desire model.

Alternatively, the desire information acquisition unit 193 may acquire the desire model of the persona format. The desire model of the persona format described herein refers to information acquired by expressing the behavior desired by the user in text.

The desire information acquisition unit 193 may generate the desire model of the persona format based on the desire model of the score format as illustrated in the example of FIG. 6. Alternatively, the desire information acquisition unit 193 may acquire, as the desire model of the persona format, information acquired such that the current-status model of the persona format is rewritten by the user.

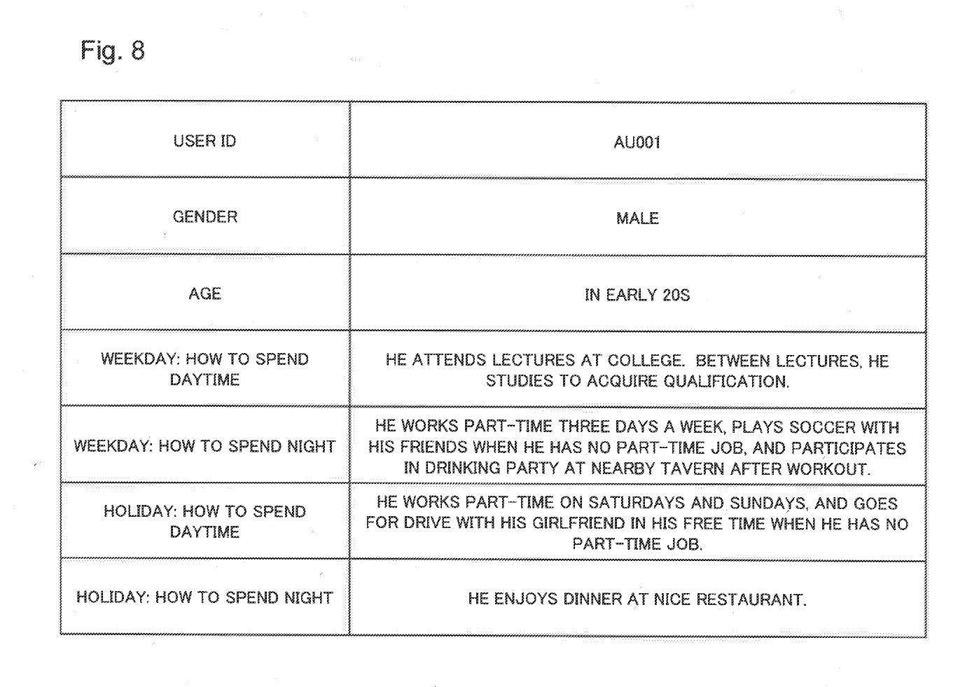

FIG. 8 is a table illustrating a display example of the desire model of the persona format. In the example of FIG. 8, the user rewrites the current-status model of the persona format as illustrated in FIG. 5, thereby acquiring the desire mode of the persona format. The user describes a desire (user's ideal) to study to acquire a qualification between lessons at a collage, as a way to spend daytime on weekdays. The user also describes a desire to go for a drive with his girlfriend when the user has no part-time job, as a way to spend daytime on holidays. The user also describes a desire to have dinner at a nice restaurant, as a way to spend night on holidays.

Note that as a method for generating a desire model, the desire information acquisition unit 193 may automatically generate the desire model, instead of the method in which the user himself/herself inputs as described above. For example, the desire information acquisition unit 193 may also be set to generate the desire model based on user's own writing, such as “want . . . ” or “want to be . . . ” in an SNS or the like, or comments or the like on other user's review or statement. Alternatively, it is also possible to employ a method for causing the user to design an avatar and extracting the desire model from the designed avatar.

The candidate acquisition unit 194 acquires a presentation information candidate. The presentation information candidate described herein refer to a candidate for information to be presented to the user.

FIG. 9 is a table illustrating an example of a group of presentation information candidates. In the example of FIG. 9, the group of presentation information candidates is configured as information of the table format, and each line corresponds to an example of the presentation information candidate. The group of presentation information candidates illustrated in FIG. 9 includes an “article ID” field, an “article name” field, and an “article explanation” field.

In the “article ID” field, an article ID is stored. The article ID is identification information for identifying an article or service.

In the “article name” field, a name (article name) of the article or service identified by the article ID is stored.

In the “article explanation” field, an explanation of the article or service (explanation of the article or explanation of the service) identified by the article ID is stored.

For example, a line L211 indicates that a service identified by an article ID “AS001” is night cruising and dinner is provided at night cruising on the sea. The line L211 corresponds to an example of provision information candidate.

The candidate acquisition unit 194 acquires, for example, web page information from a web server via the communication unit 110, and analyzes the web page information, thereby acquiring the article ID of the article or service displayed on the page, the article name, and the explanation of the article or the description of the service. Then, the candidate acquisition unit 194 generates the provision information candidate by using the acquired information, and causes the storage unit 180 to store the provision information candidate in a format providing a line of the group of provision information candidates. The candidate acquisition unit 194 may acquire information from the web page browsed by the user using the browser function unit 191, or may acquire information by a method other than user's browsing.

Further, the candidate acquisition unit 194 acquires a presentation information candidate associated with a score for each item of the desire model. Information that associates the presentation information candidate with the score may be configured as a part of the presentation information candidate, or may be configured as information separate from the presentation information candidate.

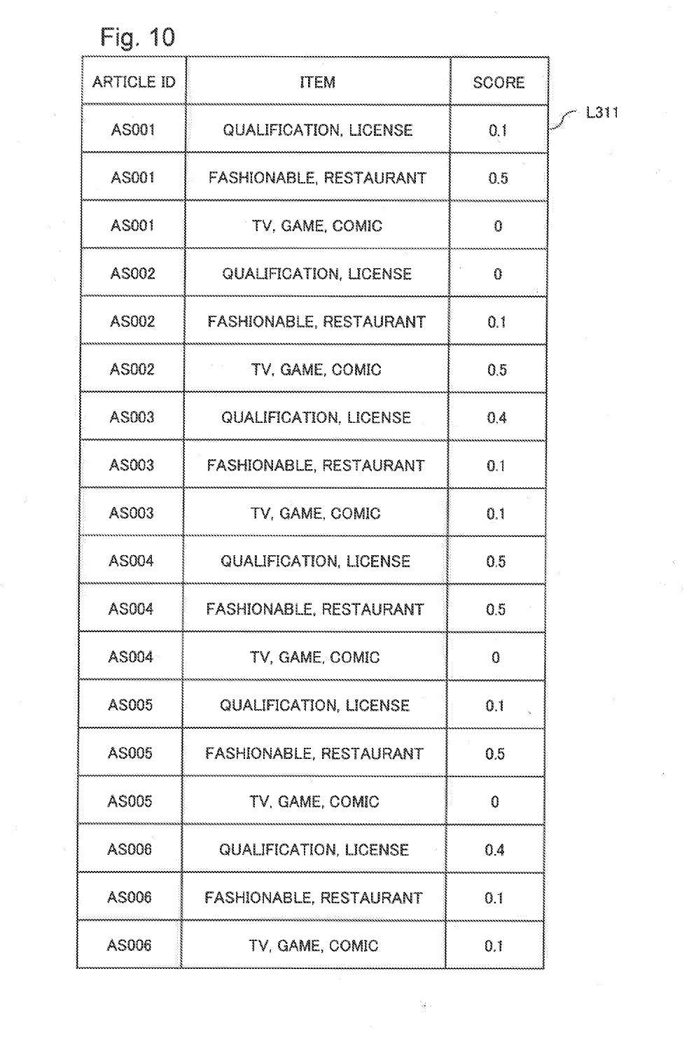

FIG. 10 is a table illustrating an example of candidate score association information. The candidate score association information described herein refers to information that associates the presentation information candidate with the score for each item. In the example of FIG. 10, the candidate score association information is configured as information of the table format, in which one article or service and a score associated with one item are displayed in each line. The candidate score association model illustrated in FIG. 10 is configured to include an “article ID” field, an “item” field, and a “score” field.

In the “article ID” field, an article ID is stored. The article ID associates lines of the candidate score association information with a line of the group of provision information candidates (i.e., one provision information candidate). In the example of FIG. 10, the same article ID is stored in a plurality of lines in the “article ID” field for the candidate score association information, and the plurality of lines of the candidate score association information are associated with one line of the group of provision information candidates.

Like in the case of the desire model, items for classifying the articles and services for each character are stored in the “item” field. A combination of the article ID and the item displayed in each line of the candidate score association information associates the score indicated in the line with one article and one item.

For example, a line L311 indicates that the score for the “qualification, license” item, which indicates night cruising (see FIG. 9) with the article ID of “AS001”, is 0.1.

The candidate acquisition unit 194 analyzes, for example, the article explanation and the service explanation in the group of presentation information candidates stored by the storage unit 180, thereby generating candidate score association information. As for the generation of the candidate score association information, a known technique such as a technique described in Japanese Unexamined Patent Application Publication No. 2010-262534 or Japanese Patent Application No. 2015-062055 (Japanese Unexamined Patent Application Publication No. 2016-181196) can be used.

As for the generation of the candidate score association information, the candidate acquisition unit 194 may extract keywords from the article explanation and the service explanation. Further, the storage unit 180 may preliminarily store information indicating a score for each keyword and for each item, and the candidate acquisition unit 194 may calculate a score by applying the extracted keywords to the information.

Alternatively, information indicating a score for each article and for each item may be preliminarily generated. For example, the score for an article or service may be indicated for each item in association with the display of the article and the display of the service on a web page. The candidate acquisition unit 194 may acquire the information to thereby acquire the candidate score association information.

Note that in the example of FIG. 10, among the items indicated in the example of the desire model illustrated in FIG. 6, an item in which the score is updated or added from the example of the current-status model illustrated in FIG. 3 and an item in which the score in the example of the desire model illustrated in FIG. 6 is greater than or equal to a predetermined threshold (e.g., 0.5) are illustrated. Each of the “qualification, license” item and the “fashionable, restaurant” item corresponds to an example of the item in which the score is updated or added from the current-status model. Further, the “TV, game, comic” item corresponds to an example of the item in which the score in the desire model is greater than or equal to the predetermined threshold.

In this manner, the item in which a score for the candidate score association information is indicated is limited, thereby making it possible to limit a load on the candidate acquisition unit 194 to generate candidate score information.

The information selection unit 195 selects information to be presented to the user among the presentation information candidates based on a difference between the current-status information and the desire information. In particular, the information selection unit 195 selects information to be presented to the user from among the presentation information candidates based on the difference between the score indicated by the desire model and the score indicated by the current-status model for each item, and the scores given to the presentation information candidates.

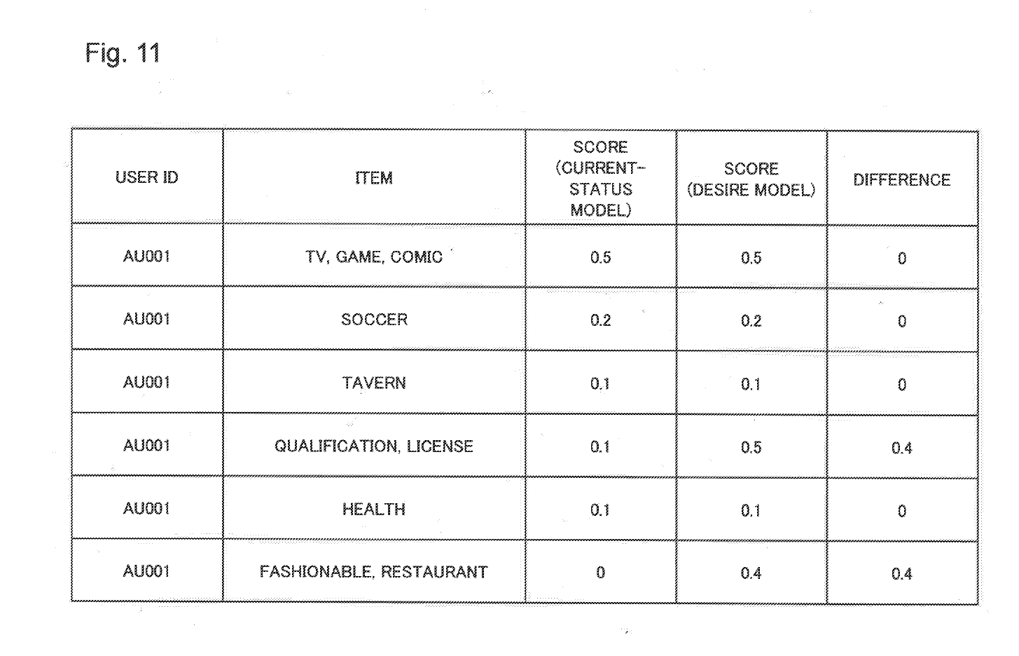

FIG. 11 is a table illustrating an example of a difference between current-status information and desire information. Specifically, FIG. 11 illustrates, for each item, a difference between the score in the current-status model illustrated in FIG. 3 and the score in the desire model illustrated in FIG. 6. Hereinafter, information indicating, for each item, the difference between the score in the current-status model and the score in the desire model is referred to as score difference information.

In the example of FIG. 11, the score difference information is configured as information of the table format, and a score for each item is indicated in each line. The score difference information illustrated in FIG. 11 includes a “user ID” field, an “item” field, a “score (current-status model)” field, a “score (desire model)” field, and a “difference” field.

In the “user ID” field, a user ID is stored.

In the “item” field, an item in which the score evaluated for any one of or both of the current-status model and the desire model is greater than or equal to zero is stored.

In the “score (current-status model)” field, the score evaluated in the current-status model is stored.

In the “score (desire model)” field, the score evaluated in the desire model is stored.

In the “difference” field, a difference obtained by subtracting the score of a corresponding item in the current-status model from the score of the corresponding item in the desire model is stored. Accordingly, the value stored in the “difference” field indicates how much the user desires to change the cost to be used for an article or a service belonging to a specific item from the current status.

The information selection unit 195 may cause the display unit 120 to display the generated score difference information. The user may check the displayed difference information, and may correct the desire model when the difference is different from that intended by the user.

Alternatively, the display unit 120 may display the current-status model and the desire model in a superimposed manner in the radar chart format under control of the control unit 190.

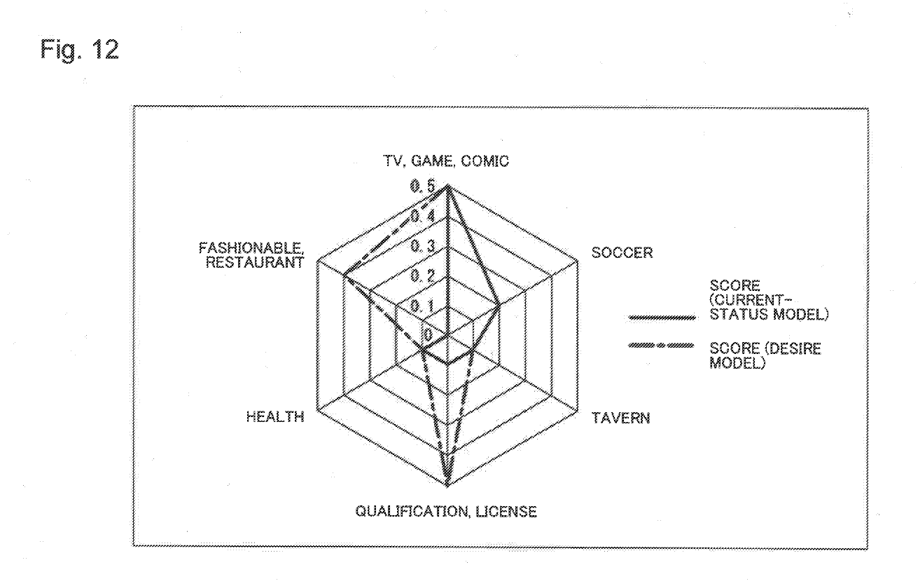

FIG. 12 is a diagram illustrating a display example in which current-status model and desire model are displayed in a superimposed manner.

In the example of FIG. 12, the current-status model illustrated in FIGS. 5 and 6 and the desire model illustrated in FIGS. 8 and 9 are displayed in a superimposed manner in the radar chart format.

In this manner, the display unit 120 displays the current-status model and the desire model in a superimposed manner in the radar chart format, thereby enabling the user to intuitively recognize the difference between the current-status model and the desire model. When the difference between the current-status model and the desire model is different from that intended by the user, the user may correct the desire model. In particular, the user may correct the desire model of the radar chart format. Thus, the user can correct the desire model without switching the screen of the display unit 120.

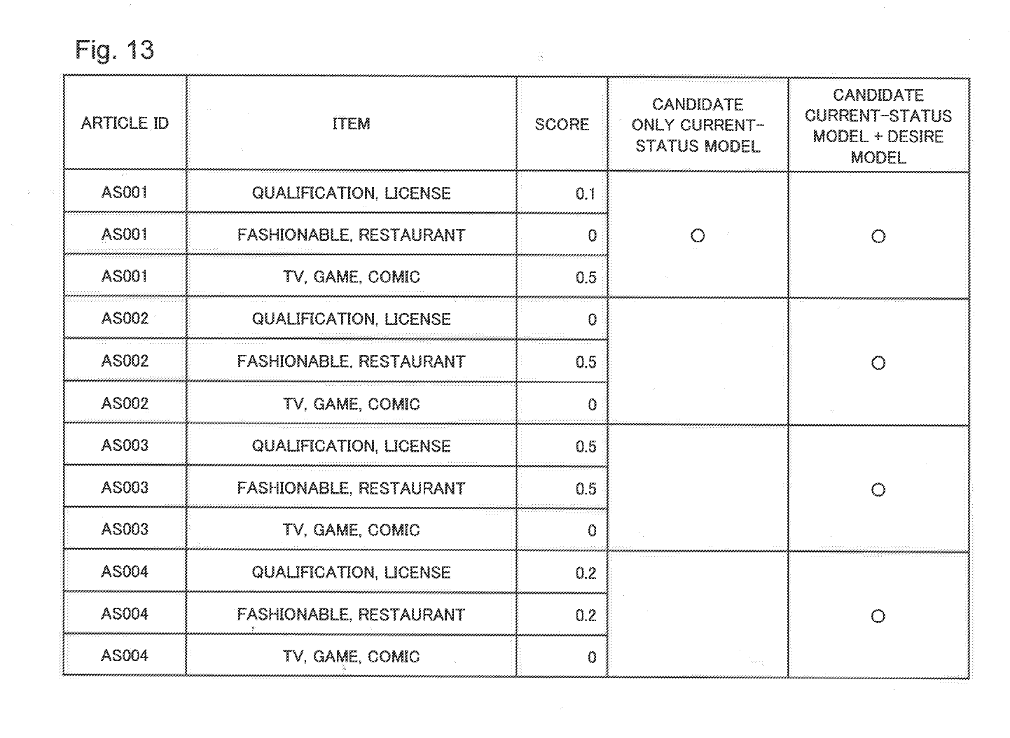

FIG. 13 is a table illustrating an example in which information is selected from presentation information candidates by the information selection unit 195. In the example of FIG. 13, whether or not to present information to the user for each article ID is illustrated, in addition to an example of the candidate score association information illustrated in FIG. 10. In each of a “candidate (only value)” field and a “candidate (with license acquisition information)” field illustrated in FIG. 13, “∘” indicates that information is presented to the user, and a blank indicates that no information is presented to the user.

Specifically, the information selection unit 195 selects information to be presented to the user from among the presentation information candidates by using the desire model.

In this case, in the current-status model illustrated in FIG. 3, the score for the “qualification, license” item is 0.1, the score for the “fashionable, restaurant” item is 0 (none), and the score for the “TV, game, comic” item is 0.5. Accordingly, if the information selection unit 195 selects information based on the current-status model without using the desire model, it can be considered that only “night cruising” with the article ID of “AS001” is presented to the user from among the presentation information candidates illustrated in FIGS. 9 and 10.

In this case, the score for “a complete series set of comics” with an article ID of “AS002” is not matched at all. As for “acquisition of qualification for project management” with an article ID of “AS003” and “training camp for driver's license” with an article ID of “AS004”, the score for the “qualification, license” item is similar to the score of the current-status model, but the “fashionable, restaurant” item is not included in the current-status model. Further, it can be considered that when the current-status model is viewed as a whole, it is determined that the user is less interested in “qualification, license”, and “qualification, license” is removed from candidates, or the priority for presentation of “qualification, license” is determined to be low.

On the other hand, when the information selection unit 195 selects information by adding the desire model to the current-status model, the score (0.4) for the “fashionable, restaurant” item and the score (0.5) for the “qualification, license” item are added. Thus, all articles illustrated in FIGS. 9 and 10 can be presented to the user. In particular, only in the current-status model, the “fashionable, restaurant” item is not present and is not determined as useful information. In contrast, by using the desire model, information about “fashionable, restaurant” can also be an object to be provided to the user.

Further, based on the score of the “difference” illustrated in FIG. 11, information that is particularly regarded as important by the user as needs is determined to be information about “fashionable, restaurant” and information about “qualification, license”. Thus, the information selection unit 195 can select information in which these two elements are regarded as important.

Note that when the difference between the current-status model and the desire model is large, the information selection unit 195 may first present information with a relatively low score. For example, in the example of FIG. 13, the information selection unit 195 may be configured in such a way that information about an article having a high score and the article ID of “AS003” is not provided to the user in the first place and information about an article for which the score is not high and the article ID of “AS004” is provided to the user intentionally. Further, the information selection unit 195 may provide the user with information about an article having a high score and the article ID of “AS003” as recommended information in the subsequent step.

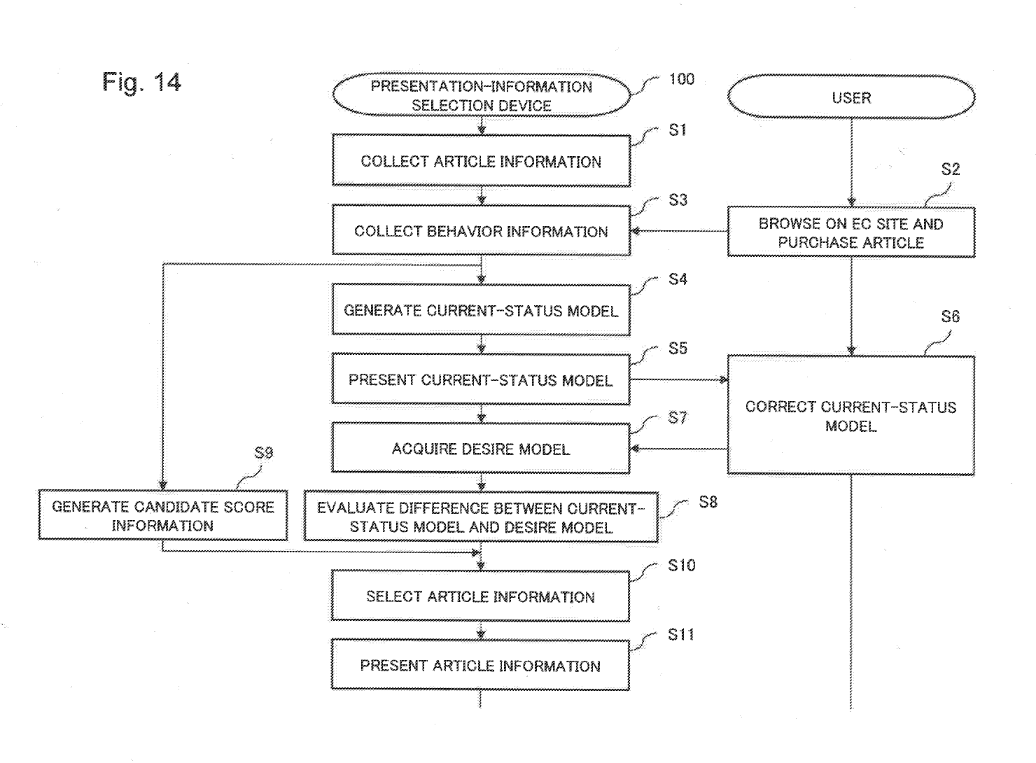

Next, an operation of the presentation-information selection device 100 will be described with reference to FIG. 14.

FIG. 14 is a sequence diagram illustrating a processing procedure for selecting information to be presented to the user by the presentation-information selection device 100.

### <Sequence S1: Collection of Article Information>

The candidate acquisition unit 194 acquires article information and service information displayed on web pages by referring to various web pages via the communication unit 110. Further, the candidate acquisition unit 194 generates presentation information candidates based on the acquired article information.

### <Sequence S2: Browsing and Purchase of Articles on an E-Commerce (EC) Site>

The user browses a website such as an EC site by using a web browser provided by the browser function unit 191. When there is a favorite article or service, the user purchases the article or service on the website.

### <Sequence S3: Collection of Behavior Information>

The current-status information acquisition unit 192 acquires, from the browser function unit 191, behavior information, such as an article browsing or purchasing history in the service utilized by the user.

### <Sequence S4: Generation of the Current-Status Model>

The current-status information acquisition unit 192 generates a current-status model based on the behavior information acquired in Sequence S3.

### <Sequence S5: Display of the Current-Status Model>

The display unit 120 displays the current-status model acquired in Sequence S4.

### <Sequence S6: Correction of the Current-Status Model>

The user corrects the current-status model displayed in Sequence S5 into an ideal model for the user himself based on the user's desire. The operation input unit 130 receives a user's operation to correct the model.

### <Sequence S7: Acquisition of the Desire Model>

The desire information acquisition unit 193 acquires the current-status model corrected by the user in Sequence S6 as a desire model.

### <Sequence S8: Evaluation of the Difference Between the Current-Status Model and the Desire Model>

The information selection unit 195 evaluates a difference between the current-status information acquired in Sequence S4 and the desire model acquired in Sequence S7. Specifically, the information selection unit 195 generates score difference information by subtracting the score in the current-status information from the score in the desire information for each item.

### <Sequence S9: Generation of Candidate Score Information>

The candidate acquisition unit 194 generates candidate score information based on the presentation information candidates acquired in Sequence S1.

### <Sequence S10: Selection of Article Information>

The information selection unit 195 selects information (article information or service information, or a combination thereof) to be presented to the user among the presentation information candidates acquired in Sequence S1. The information selection unit 195 selects information based on the score difference information acquired in Sequence S8 and the candidate score information acquired in Sequence S9.

### <Sequence S11: Presentation of Article Information>

The display unit 120 displays the article information or service information acquired in Sequence S10, or a combination thereof, thereby presenting the information to the user.

As described above, the current-status information acquisition unit 192 acquires the current-status information. The desire information acquisition unit 193 acquires desire information. Further, the candidate acquisition unit 194 acquires presentation information candidates. Then, the information selection unit 195 selects information to be presented to the user from among the presentation information candidates, based on the difference between the current-status information and the desire information.

Thus, the information selection unit 195 can provide information depending on the difference between the desire and the current status of the user in such a way as to satisfy the desire to realize the user's desire. In this manner, the information selection unit 195 can reflect the user's desire in the selection of presentation information, which leads to an increase in the possibility of presenting information desired by the user.

Further, the current-status information acquisition unit 192 acquires the current-status model acquired by converting a current status of the user into a score for each item. The desire information acquisition unit 193 acquires the desire model in which the current-status model is rewritten by the user in response to the user's own desire.

Thus, the user can generate the desire model by a relatively simple operation of rewriting the current-status model, without a need for generating a desire model from scratch. Consequently, the user's burden can be reduced.

Further, the current-status information acquisition unit 192 generates the current-status model by converting article information and service information, which are browsed by the user using a computer, into a score.

Thus, the current-status information acquisition unit 192 can generate the current-status model based on a user's browsing behavior. Since the current-status model is generated based on the user's behavior, the current-status information acquisition unit 192 can generate a user model relatively accurately.

Further, the candidate acquisition unit 194 acquires the presentation information candidate associated with a score for each item. The information selection unit 195 selects the information to be presented to the user from among the presentation information candidates, based on the difference between the score indicated by the desire model and the score indicated by the current-status model for each item, and the score for each item that is given to the presentation information candidate.

Thus, the candidate acquisition unit 194 can select information to be presented to the user by a simple process of comparing the difference between the score indicated by the desire model and the score indicated by the current-status model for each item with the score for each item that is given to the presentation information candidate.

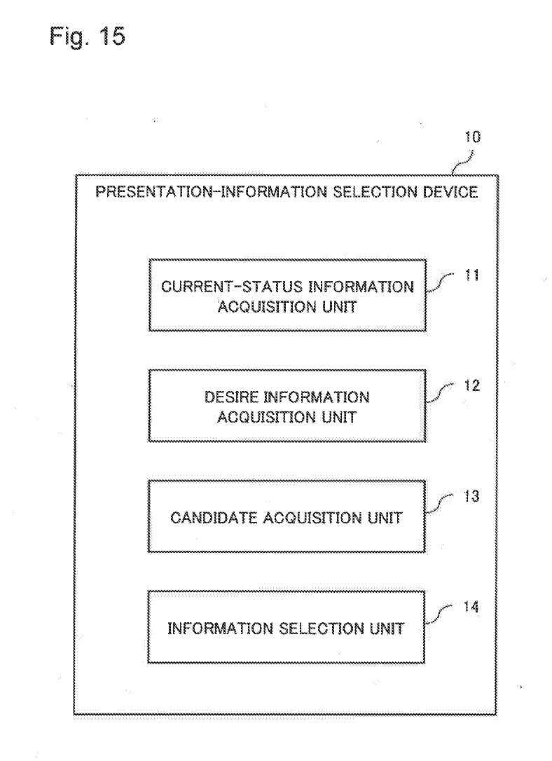

Next, the minimum configuration of the present invention will be described with reference to FIG. 15.

FIG. 15 is a schematic block diagram illustrating a minimum configuration of an information presentation device according to the present invention. A presentation-information selection device 10 illustrated in FIG. 15 includes a current-status information acquisition unit 11, a desire information acquisition unit 12, a candidate acquisition unit 13, and an information selection unit 14.

In this configuration, the current-status information acquisition unit 11 acquires current-status information that is information indicating a current status of the user. The desire information acquisition unit 12 acquires desire information that is information indicating a user's desire. The candidate acquisition unit 13 acquires presentation information candidates that are candidates for information to be presented to the user. The information selection unit 14 selects information to be presented to the user from among the presentation information candidates based on a difference between the current-status information and the desire information.

Thus, the information selection unit 14 can provide information depending on the difference between the desire and the current status of the user in such a way to satisfy a desire to realize a user's desire. In this manner, the information selection unit 14 can reflect the user's desire in the selection of presentation information, which leads to an increase in the possibility of presenting information desired by the user.

Note that processing in each unit may be performed in such a manner that a program for implementing all or some of the functions of the control unit 190 is recorded on a computer-readable recording medium and the program recorded on the recording medium is loaded into a computer system and is executed. Note that the “computer system” described herein includes hardware such as an operating system (OS) or peripheral devices.

Further, the term “computer-readable recording medium” refers to a portable medium such as a flexible disk, a magneto-optical disk, a read only memory (ROM), a compact disk (CD)-ROM, or a storage device such as a hard disk incorporated in a computer system. The above-described program may be used to implement some of the functions described above, or to implement the functions described above by a combination of programs already recorded on the computer system.

The example embodiments of the present invention have been described in detail above with reference to the drawings. However, the specific configuration is not limited to the example embodiments, and a design and the like within a range not departing from the scope of the invention can also be included.

The example embodiments of the present invention described above can be described as, but not limited to, the following supplementary notes.

### (Supplementary Note 1)

A presentation-information selection device comprising:

current-status information acquisition means for acquiring current-status information being information indicating a current status of a user;

desire information acquisition means for acquiring desire information being information indicating a desire of the user;

candidate acquisition means for acquiring a presentation information candidate being a candidate for information to be presented to the user; and

information selection means for selecting information to be presented to the user from the presentation information candidates, based on a difference between the current-status information and the desire information.

### (Supplementary Note 2)

The presentation-information selection device according to supplementary note 1, wherein

the current-status information acquisition means acquires a current-status model acquired by converting a current status of the user into a score for each item, and

the desire information acquisition means acquires a desire model in which the user has rewritten the current-status model depending on the user's own desire.

### (Supplementary Note 3)

The presentation-information selection device according to supplementary note 2, wherein the current-status information acquisition means generates the current-status model by converting article information and service information into a score, the article information and the service information being browsed by the user by using a computer.

### (Supplementary Note 4)

The presentation-information selection device according to supplementary note 2 or 3, wherein

the candidate acquisition means acquires the presentation information candidate associated with a score for each of the items, and

the information selection means selects information to be presented to the user among the presentation information candidates, based on a difference between a score indicated by the desire model and a score indicated by the current-status model for each of the items, and a score given to the presentation information candidate for each of the items.

(Supplementary note 5)

A presentation-information selection method comprising:

acquiring current-status information being information indicating a current status of a user;

acquiring desire information being information indicating a desire of the user;

acquiring a presentation information candidate being a candidate for information to be presented to the user; and

selecting information to be presented to the user among the presentation information candidates, based on a difference between the current-status information and the desire information.

### (Supplementary Note 6)

The presentation-information selection method according to supplementary note 5, further comprising:

acquiring a current-status model acquired by converting a current status of the user into a score for each item, as the current-status information; and

acquiring a desire model in which the user has rewritten the current-status model depending on the user's own desire, as the desire information.

### (Supplementary Note 7)

The presentation-information selection method according to supplementary note 6, further comprising generating the current-status model by converting article information and service information into a score, the article information and the service information being browsed by the user by using a computer.

(Supplementary Note 8)

The presentation-information selection method according to supplementary note 6 or 7, further comprising:

acquiring the presentation information candidate associated with a score for each of the items; and

selecting information to be presented to the user among the presentation information candidates, based on a difference between a score indicated by the desire model and a score indicated by the current-status model for each of the items, and a score given to the presentation information candidate for each of the items.

### (Supplementary Note 9)

A recording medium recording a program for causing a computer to execute:

acquiring current-status information being information indicating a current status of a user;

acquiring desire information being information indicating a desire of the user;

acquiring a presentation information candidate being a candidate for information to be presented to the user; and

selecting information to be presented to the user among the presentation information candidates, based on a difference between the current-status information and the desire information.

### (Supplementary Note 10)

The recording medium according to supplementary note 9, wherein the program causes the computer to further execute:

acquiring a current-status model acquired by converting a current status of the user into a score for each item, as the current-status information; and

acquiring a desire model in which the user has rewritten the current-status model depending on the user's own desire, as the desire information.

### (Supplementary Note 11)

The recording medium according to supplementary note 10, wherein the program causes the computer to further execute

generating the current-status model by converting article information and service information into a score, the article information and the service information being browsed by the user by using a computer.

### (Supplementary Note 12)

The recording medium according to supplementary note 10 or 11, wherein the program causes the computer to further execute:

acquiring the presentation information candidate associated with a score for each of the items; and

selecting information to be presented to the user among the presentation information candidates, based on a difference between a score indicated by the desire model and a score indicated by the current-status model for each of the items, and a score given to the presentation information candidate for each of the items.

### (Supplementary Note 13)

The recording medium according to supplementary note 11 or 12, wherein the program causes the computer to further execute:

acquiring the presentation information candidate associated with a score for each of the items; and

selecting information to be presented to the user among the presentation information candidates, based on a difference between a score indicated by the desire model and a score indicated by the current-status model for each of the items, and a score given to the presentation information candidate for each of the items.

This application is based upon and claims the benefit of priority from Japanese Patent Application No. 2016-185578, filed on Sep. 23, 2016, the disclosure of which is incorporated herein in its entirety by reference.

### REFERENCE SIGNS LIST

100 Presentation-information selection device

110 Communication unit

120 Display unit

130 Operation input unit

180 Storage unit

190 Control unit

191 Browser function unit

192 Current-status information acquisition unit

193 Desire information acquisition unit

194 Candidate acquisition unit

195 Information selection unit

What is claimed is:

1. A presentation-information selection device comprising:
a memory storing a computer program;
at least one processor executing the computer program to perform:
acquiring current-status information being information indicating a current status of a user;
acquiring desire information being information indicating a desire of the user;
acquiring a presentation information candidate being a candidate for information to be presented to the user; and
selecting information to be presented to the user from the presentation information candidates, based on a difference between the current-status information and the desire information.

2. The presentation-information selection device according to claim 1, wherein
the at least one processor executes the computer program to perform:
acquires acquiring a current-status model acquired by converting a current status of the user into a score for each item, and
acquires acquiring a desire model in which the user has rewritten the current-status model depending on the user's own desire.

3. The presentation-information selection device according to claim 2, wherein the at least one processor executes the computer program to perform:
generating the current-status model by converting article information and service information into a score, the article information and the service information being browsed by the user by using a computer.

4. The presentation-information selection device according to claim 2, wherein the at least one processor executes the computer program to perform:
acquiring the presentation information candidate associated with a score for each of the items, and
selecting information to be presented to the user among the presentation information candidates, based on a difference between a score indicated by the desire model and a score indicated by the current-status model for each of the items, and a score given to the presentation information candidate for each of the items.

5. A presentation-information selection method comprising:
acquiring current-status information being information indicating a current status of a user;
acquiring desire information being information indicating a desire of the user;
acquiring a presentation information candidate being a candidate for information to be presented to the user; and
selecting information to be presented to the user among the presentation information candidates, based on a difference between the current-status information and the desire information.

6. The presentation-information selection method according to claim 5, further comprising:
acquiring a current-status model acquired by converting a current status of the user into a score for each item, as the current-status information; and
acquiring a desire model in which the user has rewritten the current-status model depending on the user's own desire, as the desire information.

7. The presentation-information selection method according to claim 6, further comprising generating the current-status model by converting article information and service information into a score, the article information and the service information being browsed by the user by using a computer.

8. The presentation-information selection method according to claim 6, further comprising:
acquiring the presentation information candidate associated with a score for each of the items; and
selecting information to be presented to the user among the presentation information candidates, based on a difference between a score indicated by the desire model and a score indicated by the current-status model for each of the items, and a score given to the presentation information candidate for each of the items.

9. A recording medium recording a program for causing a computer to execute:
acquiring current-status information being information indicating a current status of a user;
acquiring desire information being information indicating a desire of the user;
acquiring a presentation information candidate being a candidate for information to be presented to the user; and
selecting information to be presented to the user among the presentation information candidates, based on a difference between the current-status information and the desire information.

10. The recording medium according to claim 9, wherein the program causes the computer to further execute:
acquiring a current-status model acquired by converting a current status of the user into a score for each item, as the current-status information; and
acquiring a desire model in which the user has rewritten the current-status model depending on the user's own desire, as the desire information.

11. The recording medium according to claim 10, wherein the program causes the computer to further execute
generating the current-status model by converting article information and service information into a score, the article information and the service information being browsed by the user by using a computer.

12. The recording medium according to claim 10, wherein the program causes the computer to further execute:
acquiring the presentation information candidate associated with a score for each of the items; and
selecting information to be presented to the user among the presentation information candidates, based on a difference between a score indicated by the desire model and a score indicated by the current-status model for each of the items, and a score given to the presentation information candidate for each of the items.

13. The recording medium according to claim 11, wherein the program causes the computer to further execute:
acquiring the presentation information candidate associated with a score for each of the items; and
selecting information to be presented to the user among the presentation information candidates, based on a difference between a score indicated by the desire model and a score indicated by the current-status model for each of the items, and a score given to the presentation information candidate for each of the items.
